(19) United States
(12) Patent Application Publication
(10) Pub. No.: US 2007/0000822 A1
(43) Pub. Date: Jan. 4, 2007

(54) Bill handling device

(75) Inventor: Kazuei Yoshioka, Koto-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: Aruze Corp., Koto-ku (JP); Seta Corp., Koto-ku (JP)

(21) Appl. No.: 11/440,058

(22) Filed: May 25, 2006

(30) Foreign Application Priority Data
Jun. 17, 2005 (JP) 2005-178271

(51) Int. Cl. B07C 5/00

(52) U.S. Cl. 209/534

(57) ABSTRACT

A bill handling device according to one embodiment of the invention is provided with a casing having a bill handling opening enabling a bill to be inserted therein; a bill feeding device for feeding the bill inserted from the bill handling opening along the insertion direction, and for feeding the bill in an insertion state back to the bill handling opening; a bill identifying sensor that identifies the validity of the bill inserted into the bill handling opening; a guide device for curving and guiding a front end of the bill in a fed state when the bill is in the fed state along the insertion direction and the bill identifying sensor is detecting the validity of the bill; a bill storage portion that is provided in parallel with the bill feeding device and that stacks and stores the bill in the direction perpendicular to the bill insertion direction; a control device for controlling switch back of the bill feeding device so as to feed the bill to the bill handling opening side by a predetermined distance when the inserted bill is valid; and a separation device that stacks and stores the switch backed bill in the bill storage portion, while making a separation between the bill and a subsequently inserted bill.

The present disclosure relates to subject matter contained in Japan Patent Application No. 2004-344937 filed on Nov. 29, 2004, Japan Patent Application No. 2005-50928 filed on Feb. 25, 2005, and Japan Patent Application No. 2005-178271 filed on Jun. 17, 2005, which are expressly incorporated herein by reference in its entireties.

### BACKGROUND OF THE INVENTION

The present invention relates to a bill handling device that identifies bills to store, and more particularly, to the bill handling device which is installed in a game hall where, for example, pachinko machines, slot machines (hereinafter, collectively referred to as a “game machine”) and the like are installed, and which is capable of being disposed between game machines.

Generally, in a game hall such as a pachinko hall, for game player's convenience, in a region (also referred to as an “bank”) where many game machines are installed, a vertically oriented game media lending apparatus (also referred to as a “sandwich apparatus”) is installed between adjacent game machines to lend pachinko balls, coins (game media) and the like. The game media lending apparatus is attached to a frame fixed and installed between game machines, and actually lends game media and/or transmits a signal to urge to lend game media to a game machine by a bill, coin, prepaid card or the like being inserted through a corresponding insertion slot.

For example, a game media lending apparatus configured to handle bills, coins and prepaid cards has a bill handling device, a coin handling apparatus, a recording media handling apparatus that takes in a recording medium such as a prepaid card, IC card and the like to read recorded information and/or write information, a controller that controls each apparatus while transmitting a signal to urge to lend game media to a game machine, and a power supply.

The bill handling device as described above has a bill identifying portion that identifies an inserted bill, and a bill storage portion (safety box) that stores bills judged as being valid in the bill identifying portion, for example, as disclosed in JP H07-23757. This well-known bill handling device is configured to carry a bill inserted in a bill insertion slot to the back by a feeding mechanism, while reading out the validity of the bill by a sensor, and carry a bill judged as being valid further to the back, while ejecting a bill judged as being-not valid from the insertion slot by driving the feeding mechanism in reverse rotation. Then, the bill judged as being valid is stacked sequentially in the bill storage portion existing at the side by rotary-driving a pair of rotary guide bars engaging in opposite sides of the bill that is carried to the back.

Generally, the bill identifying portion disposed in the bill handling device is configured to emit a light beam to an inserted bill, compare detected data obtained by the reflected light and/or transmitted light with beforehand stored data on the authorized bill, and judge the validity of the bill. In this case, in identifying a bill, it is preferable to detect the entire longitudinal region of the bill to carry in terms of improving the accuracy in identification.

However, when the bill handling device of well-known technique as described above is configured to detect the entire longitudinal region of the bill to carry, a problem arises that the space at the back becomes waste as the whole of the apparatus. In other words, the apparatus performs identification processing on a bill in carrying the bill to the back, shifts the bill to the side when the entire longitudinal region has been read, and therefore, needs the space at least equal to the length of a bill or more in the downstream portion of the bill identifying sensor. Generally, the game media lending apparatus installed between game machines as described above is required to reduce its size as much as possible, and the bill handling device incorporated in the lending apparatus is also required to be compact in size and accommodated in limited space.

Further, when in making the entire bill handling device compact, the possibility becomes high that interference and/or collision occurs between the processing for storing a bill judged as being correct after finishing the identification and the processing for identifying a subsequently inserted bill. Therefore, the apparatus is desirably configured to achieve the processing for making a separation between such bills in a stable state. Further, in making the entire bill handling device compact, the apparatus desirably has such a construction that various structural members incorporated therein are disposed efficiently, and that each operation of transport, storage and ejection of bill is made efficient.

Accordingly, a bill handling device is required which is made compact effectively using the limited installation space without degrading the accuracy in identification of bill, and which enables sequentially inserted bills to be handled in a stable state.

### BRIEF SUMMARY OF THE INVENTION

In an aspect of the present invention, there is provided a bill handling device having a casing having a bill handling opening enabling a bill to be inserted therein; a bill feeding device for feeding the bill inserted from the bill handling opening along the insertion direction, and for feeding the bill in an insertion state back to the bill handling opening; a bill identifying sensor that identifies the validity of the bill inserted into the bill handling opening; a guide device for curving and guiding a front end of the bill in a fed state when the bill is in the fed state along the insertion direction and the bill identifying sensor is detecting the validity of the bill; a bill storage portion that is provided in parallel with the bill feeding device and that stacks and stores the bill in the direction perpendicular to the bill insertion direction; a control device for controlling switch back of the bill feeding device so as to feed the bill to the bill handling opening side by a predetermined distance when the inserted bill is valid; and a separation device that stacks and stores the switch backed bill in the bill storage portion, while making a separation between the bill and a subsequently inserted bill.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an entire structure of one embodiment of a bill handling device according to the present invention;

FIG. 2 is a view showing an internal structure of the bill handling device;

FIG. 3 is a perspective view showing a structure of guide means for curving and guiding a front end of a bill in a fed state;

FIG. 4A is a view showing a state where the guide means is in an initial position, as seen from the direction of the arrow C of FIGS. 1 and 2;

FIG. 4B is a view showing a state where bills stacked and stored in a bill storage portion and a subsequently fed bill are separated, as seen from the direction of the arrow C of FIGS. 1 and 2;

FIG. 5A is a view to explain the operation of a shutter mechanism that ejects bills, showing the shutter mechanism being closed;

FIG. 5B is another view to explain the operation of the shutter mechanism that ejects bills, showing the shutter mechanism being opened;

FIG. 6A is an enlarged view of principal part of FIG. 5A;

FIG. 6B is an enlarged view of principal part of FIG. 5B;

FIG. 7 is a plan view showing a structure of a pushing mechanism;

FIG. 8A is a perspective view showing the structure of the pushing mechanism before bills are ejected;

FIG. 8B is a perspective view showing the structure of the pushing mechanism when bills are ejected;

FIG. 9 is a view showing a state where bills are ejected from the bill handling device;

FIG. 10 is a block diagram illustrating an example of configuration of control means for controlling the operation of the bill handling device; and

FIGS. 11A to 11F are schematic views successively illustrating the operation of a bill feeding mechanism and guide means when a bill is inserted.

### DETAILED DESCRIPTION OF THE INVENTION

One embodiment of the present invention will be described below with reference to accompanying drawings.

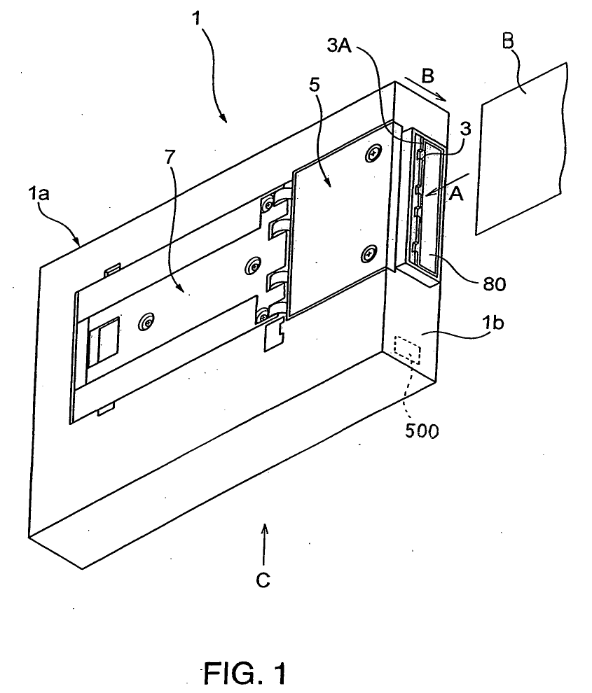

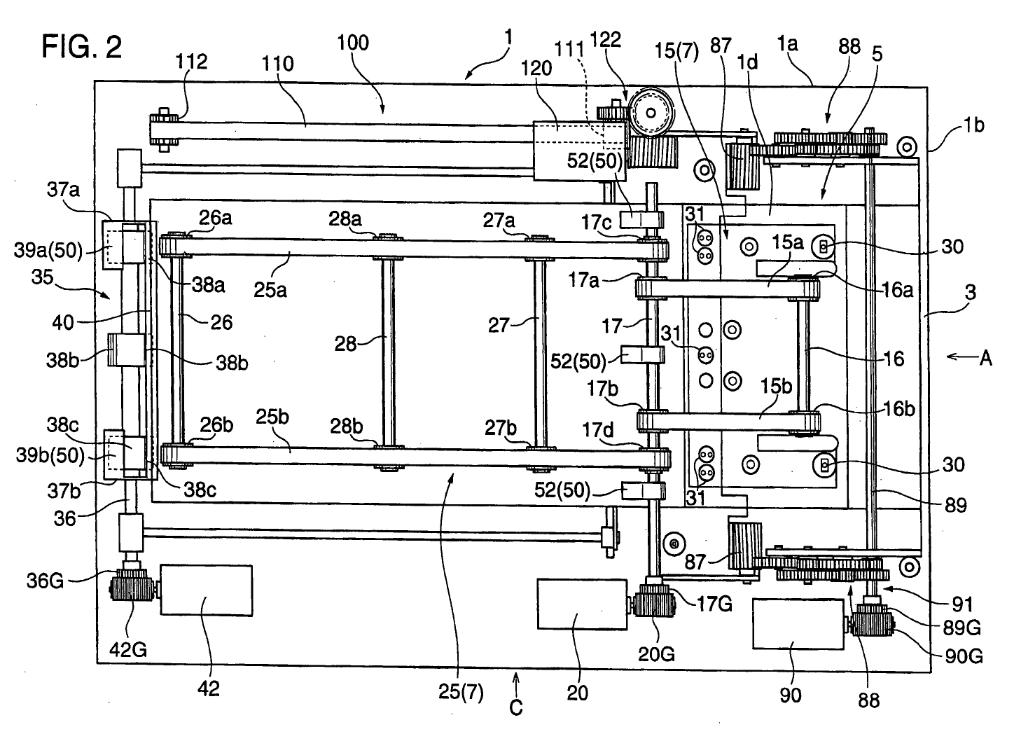

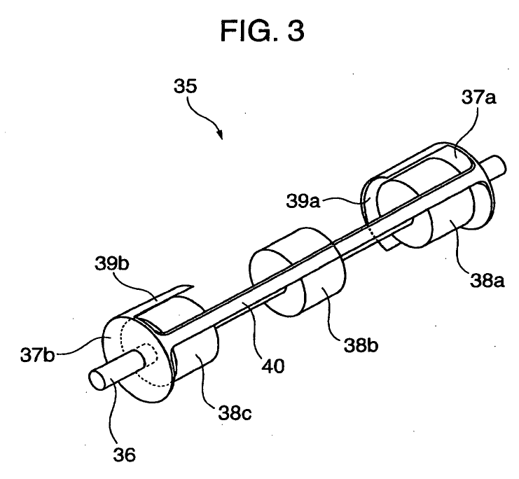

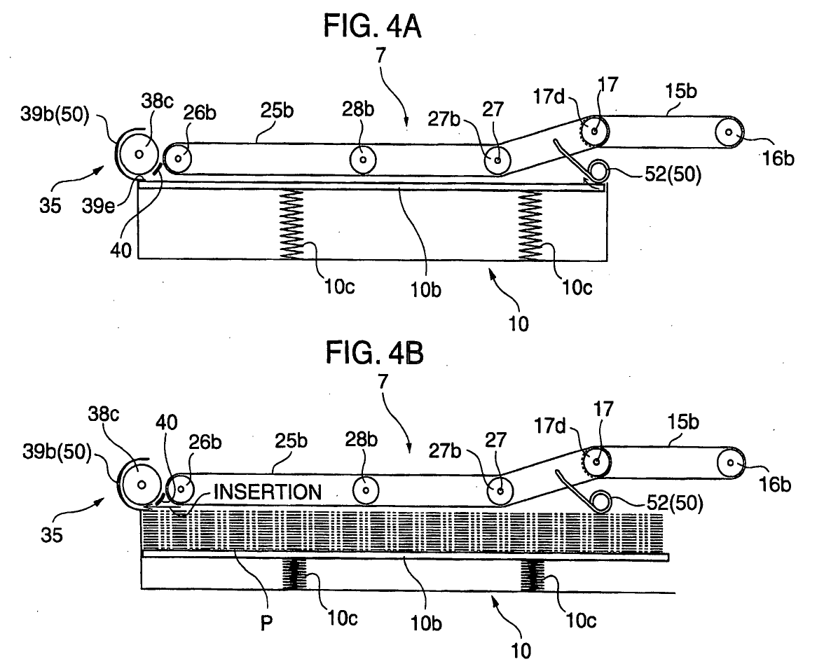

FIGS. 1 to 4(4A,4B) are views showing a structure of a bill handling device according to this embodiment. FIG. 1 is a perspective view showing the entire structure. FIG. 2 is a view showing the internal structure. FIG. 3 is a view showing a structure of guide means (guide device) for curving and guiding a front end of a bill in a fed state. FIGS. 4A and 4B are views as seen from the direction of the arrow C of FIGS. 1 and 2, where FIG. 4A shows a state where the guide means is in an initial position, and FIG. 4B shows a state where bills stacked and stored in a bill storage portion and a subsequently fed bill are separated.

The bill handling device 1 is configured to enable its installation into a game media lending apparatus installed between game machines such as, for example, pachinko machines, slot machines and the like (not shown). In this case, the game media lending apparatus is provided with other apparatuses (for example, a coin identifying apparatus, recording media handling apparatus, power supply apparatus and the like) above or under the bill handling device 1, and the bill handling device 1 may be integrated with the other apparatuses or may be configured alone. Alternately, the bill handling device 1 may be installed alone or with the other apparatuses in the space other than between game machines. Also, the bill handling device 1 may be incorporated within a game machine. Then, when a bill is inserted into such a bill handling device 1 and the validity of the inserted bill is judged, the apparatus 1 performs processing of lending game media, processing of writing in a recording medium or the like corresponding to an amount of the bill.

The bill handling device 1 has a casing 1a formed in the shape of a cuboid, and the casing 1a is attached to an engagement portion of the game media lending apparatus not shown. On the front face 1b of the casing 1a is formed a bill handling opening 3A through which a bill is inserted and ejected. The bill handling opening 3A is divided into an insertion region (a bill insertion slot 3 opened in the form of a slit) enabling a single bill to be passed through, and an ejection region (shielded by a shutter mechanism 80) enabling bills stacked and stored in a bill storage portion to be collectively ejected while keeping the stacked state. In this case, the bill B is inserted inside via the bill insertion slot 3 along the direction of the arrow A with short sides of the bill in the lengthwise direction (standing state).

In the casing 1a are provided a bill identifying portion 5 that identifies the validity of an inserted bill, a bill feeding mechanism (bill feeding device, bill feeding means) 7 that feeds the inserted bill, and a bill storage portion (bill storage means) 10 that stacks and stores bills judged as being valid. In this case, the bill identifying portion 5 is provided in the position near the bill insertion slot 3 in the insertion direction, and the bill feeding mechanism 7 is provided over a region along the insertion direction A from the bill identifying portion 5. The bill storage portion 10 is disposed to be parallel with the bill feeding mechanism 7, and configured to be able to stack and store bills while keeping the bills in a stand state, in the direction B denoted by the arrow which is the direction perpendicular to the insertion direction A (in FIG. 2, bills are sequentially stacked and stored toward the back that is the perpendicular direction to the sheet.)

The bill identifying portion 5 is provided with a first feeding mechanism (first feeding device) 15 that feeds the bill inserted into the bill insertion slot 3 while keeping the vertical state of the bill to pull inside (the first feeding mechanism constitutes part of the bill feeding mechanism 7.) In this case, the first feeding mechanism 15 extends along the bill insertion direction A, and is provided with a pair of feeding belts 15a, 15b spaced a predetermined distance apart from each other. The feeding belts 15a, 15b are wound at one end around tension rollers 16a, 16b attached to a spindle 16 supported rotatably by an internal frame 1d on the bill insertion slot 3 side, while being wound at the other end around tension rollers 17a, 17b attached to a spindle 17 supported rotatably by the internal frame 1d at the back of the bill identifying portion 5, respectively.

The spindle 17 is rotary-driven by a feeding motor 20 disposed in the internal frame 1d. In other words, the spindle 17 is rotary-driven via a gear 20G fixed to a driving shaft of the feeding motor 20 and a gear 17G, engaging in the gear 20G, fixed to an end portion of the spindle 17. The feeding motor 20 is controlled to be driven in forward rotation and reverse rotation, and has the function as a driving source of the bill feeding mechanism 7.

In addition, the feeding belts 15a, 15b are brought into contact with pinch rollers not shown along the longitudinal direction, and the bill B inserted into the bill insertion slot is fed while being pinched by the feeding belts 15a, 15b and the pinch rollers in contact with the feeding belts.

The bill feeding mechanism 7 is provided with a second feeding mechanism (second feeding device) 25 installed continuously with the first feeding mechanism 15. The second feeding mechanism 25 has a pair of feeding belts 25a, 25b, extending along the bill insertion direction A, wider than the feeding belts 15a, 15b constituting part of the first feeding mechanism 15. The feeding belts 25a, 25b are wound at one end around tension rollers 17c, 17d attached to the outside of tension rollers 17a, 17b of the spindle 17, while being wound at the other end around tension rollers 26a, 26b attached to a spindle 26 supported rotatably by the internal frame 1d, respectively. In this case, the length between the spindles 17 and 26 is set to be shorter than the length of the bill.

In addition, two spindles, 27 and 28, are supported rotatably by the internal frame 1d along the bill feeding direction in between the spindles 17 and 26 to apply tension to the feeding belts 25a, 25b. The feeding belts 25a, 25b are wound around the tension rollers 27a, 28a and tension rollers 27b, 28b attached to respective spindles, respectively. Further, the spindle 27 is supported with an offset relative to the spindle 17 (see FIG. 4 (4A, 4B)). This is because of reserving an amount of the curve displacement, since the front end of the fed bill is guided to curve as described later.

The pair of feeding belts 25a, 25b constituting part of the second feeding mechanism 25 is controlled to be driven in forward rotation and reverse rotation by the feeding motor 20 that rotary-drives the spindle 17, as in the first feeding mechanism 15.

The bill identifying portion 5 has a bill insertion sensor 30 provided closer to the bill insertion slot 3 than the spindle 16. The bill insertion sensor 30 is comprised of, for example, an optical sensor, and detects that a bill is inserted into the bill insertion slot 3. Then, when the bill insertion sensor 30 detects insertion of a bill, control means (control device) described later rotary-drives (drives in forward rotation) the feeding motor 20 in the bill feeding direction.

The bill identifying portion 5 further has bill identifying sensors (bill identifying means) 31 installed between the spindles 16 and 17. Each of the bill identifying sensors 31 is comprised of an optical sensor to emit a light beam to a fed bill when the bill is fed by the bill feeding mechanism 7 as described above. The bill identifying sensors 31 are installed in a plurality of portions along the direction perpendicular to the bill insertion direction A. A CPU of the control means described later compares detected data obtained by the reflected light and/or transmitted light from the bill with data on an authorized bill beforehand stored in ROM, and judges the validity of the bill. Then, in this embodiment, it is constructed to detect the entire longitudinal region of a fed bill in identifying the bill.

Downstream of the spindle 26 constituting part of the bill feeding mechanism 7 is further provided guide means 35 that curves the front end portion of the fed bill to guide. The guide means 35 is installed in a position where the front end of the bill is guided while being curved when the rear end of the fed bill is passed by the bill identifying sensors 31.

As shown in FIGS. 2 and 3, the guide means 35 has a rotary driving shaft 36 disposed in parallel with the spindle 26. The rotary driving shaft 36 is provided at opposite ends with disk-shaped plates 37a, 37b fixed to the shaft 36 to rotate integrally, and three rollers, 38a, 38b, 38c, are supported rotatably between the plates 37a, 37b while being spaced a predetermined distance apart from one another. Arch-shaped guide plates 39a, 39b are integrally formed respectively in the plates 37a, 37b along the shaft direction with a predetermined distance (distance to such an extent that a bill is moved and guided along the outer circumference surfaces of the rollers 38a, 38b, 38c) from the outer circumference surfaces of the rollers 38a, 38b, 38c.

The arch-shaped guide plates 39a, 39b have the separation function of making a separation between a bill to be stacked and stored in the bill storage portion 10 and a fed bill (to prevent interference between the bill to be stacked and stored and the fed bill) by their arch-shaped outer circumference surfaces, as well as the function of guiding the front end of the bill in the shape of a curve by their inner surfaces and the outer circumferences of the rollers 38a, 38c.

Further, a guide bar 40 is laid between the plates 37a, 37b to guide the front end portion of the fed bill smoothly into the clearance between the guide plates 39a, 39b and the outer circumference surfaces of the rollers 38a, 38c, while preventing the bill from coming into between the feeding belts 25a, 25b and rollers 38a, 38c (to prevent the occurrence of jam such as inclusion), respectively.

The rotary driving shaft 36 is rotary-driven by a separation motor 42 disposed in the internal frame 1d. In other words, the rotary driving shaft 36 is rotary-driven via a gear 42G fixed to a driving shaft of the separation motor 42 and a gear 36G, engaging in the gear 42G, fixed to an end portion of the rotary driving shaft 36. The separation motor 42 is controlled in rotary driving intermittently in association with driving of the feeding motor 20.

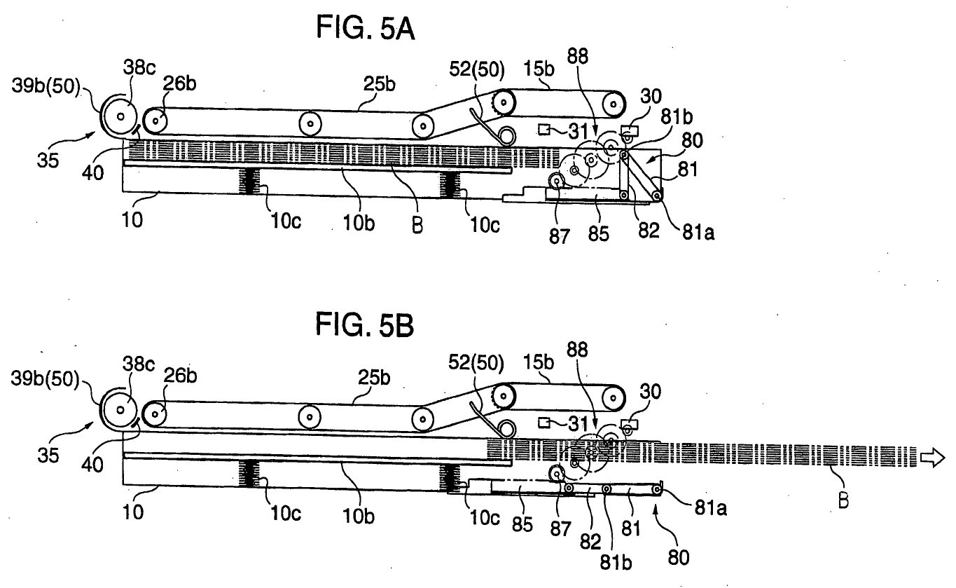

The bill storage portion 10 is disposed in parallel with the bill feeding mechanism 7 (disposed at the back of the sheet in FIG. 2) to enable a bill existing in the bill feeding mechanism 7 to be stacked and stored with its state kept. More specifically, as shown in FIGS. 4A and 4B, the bill storage portion 10 is configured to store a predetermined number of bills to be stacked, and has a mount plate 10b disposed in parallel with the feeding belts 25a, 25b, and force-applying springs (biasing spring) 10c as force applying means (urging means) that apply the force (urge) to the mount plate 10b toward the bill feeding mechanism 7 side (as shown in FIG. 4B, the bill is sequentially stacked and stored on the mount plate 10b against the force applied by the force-applying springs 10c.) Further, the openable/closable shutter mechanism 80 (see FIGS. 5A and 5B) is disposed at the bill insertion slot side of the bill storage portion 10 to enable stored stacked bills to be removed easily, and the stacked bills are ejected by a pushing mechanism described later without change.

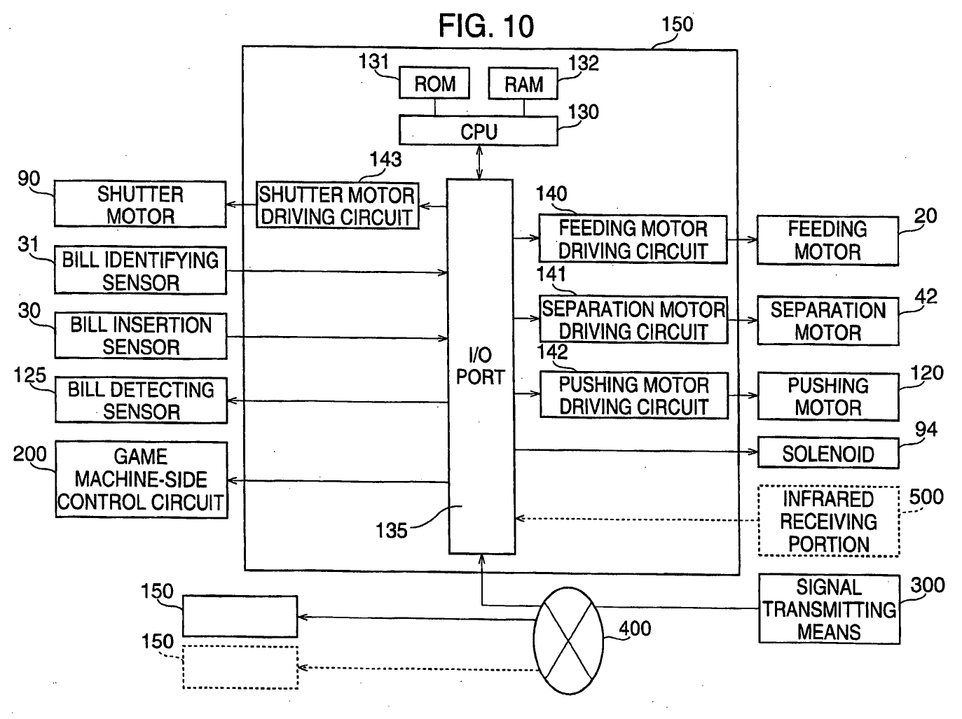

In addition, the bill storage portion 10 may be provided with a bill detecting sensor (bill detecting means) 125 (see the block diagram in FIG. 10) to detect the existence of a bill on the mount plate 10b.

Between the bill storage portion 10 and bill feeding mechanism 7 is provided a separation mechanism (separation device, separation means) 50 to perform separation such that a bill judged as being valid is stacked to be stored in the bill storage portion 10 while the feeding path is opened for a subsequently inserted bill. The separation mechanism 50 has the function for sequentially bringing a bill judged as being valid into contact with the mount plate 10b, while separating a subsequently inserted bill not to interfere with the stored stacked bill.

The separation mechanism 50 of this embodiment is comprised of outer circumference surfaces of the above-mentioned rotary-driven arch-shaped guide plates 39a, 39b and switching valves 52 disposed between the spindle 17 and the bill storage portion 10. In this case, as shown in FIG. 4B, the guide plates 39a, 39b engage in one end side of a bill in the longitudinal direction, and the switching valves 52 are capable of engaging in the other end side of the bill in the longitudinal direction.

The guide plates 39a, 39b are rotary-driven by the separation motor 42 being rotary-driven, and in the initial state as shown in FIG. 4A, has the function such that each outer circumference surface comes into contact with an upper surface of the end portion of the bill stacked and stored, and presses the bill toward the mount plate 10b side against the force applied by the force-applying springs 10c. Further, an end-portion region of the outer circumference surface of each of the guide plates 39a, 39b has the function of coming into contact with the end portion of the bills stacked and stored in the bill storage portion 10 to press the bills as shown in FIG. 4B, while each end edge 39e opens the feeding path of a next fed bill to perform separation between a sequentially fed bill and the bills stacked and stored.

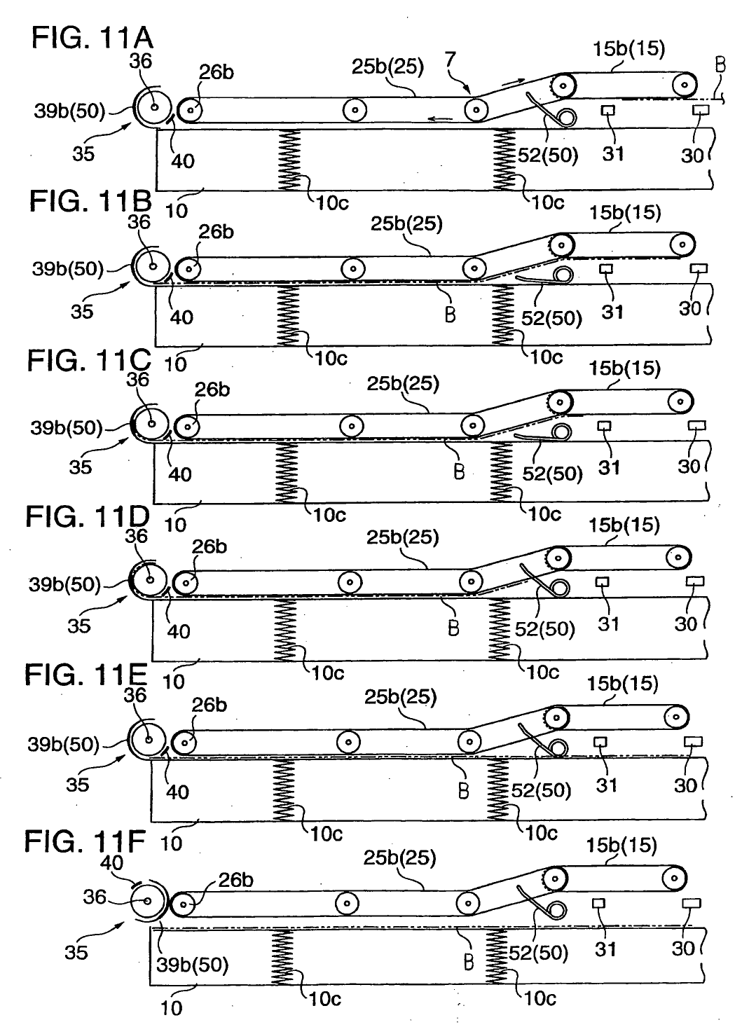

Meanwhile, as shown in FIGS. 2 and 4(4A, 4B), the above-mentioned switching valves 52 are plate-shaped members installed to be able to come into contact with an inserted bill in equal positions (three portions, center and opposite end portions) in the width direction, and supported so that the valves are urged toward the direction of closing an insertion path of an inserted bill by the applied force to the valve (in FIG. 4(4A, 4B), the force is applied clockwise.) The applied force (urging force) is set to such an extent that when a bill is inserted, the feeding force of the bill enables the switching valves 52 to rotate easily counterclockwise against the applied force, as shown in FIGS. 11A to 11C. In other words, the surface of each of the switching valves 52 on the bill storage portion 10 side comes into contact with the end portion of the bill to be stacked and stored in the bill storage portion 10, whereby implementing the separation function for making a separation between the inserted bill and the stored bill.

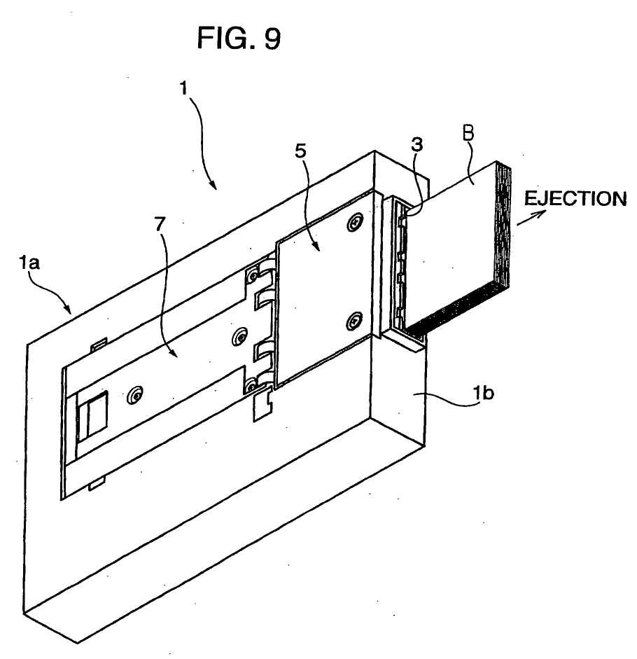

The above-mentioned bills stacked and stored in the bill storage portion 10 can be removed with their stacked state kept by driving and opening the shutter mechanism 80 disposed in parallel with the bill insertion slot 3 in the bill handling opening 3A (see FIG. 9) . The shutter mechanism 80 is comprised of a shield plate 81 to close the ejection region of the bill handling opening 3A while inclining, and a coupling member (rotary arm plate) 82 coupled to the shield plate 81. In this case, the shield plate 81 is supported rotatably at one end portion 81a by a frame of the apparatus body, while being supported rotatably at the other end portion 81b by one end portion of the coupling member 82. The other end portion 82a of the coupling member 82 is supported rotatably, on opposite sides in the direction perpendicular to the bill insertion direction, by a pair of rack members 85 (one side is only shown) provided movably along the bill feeding direction.

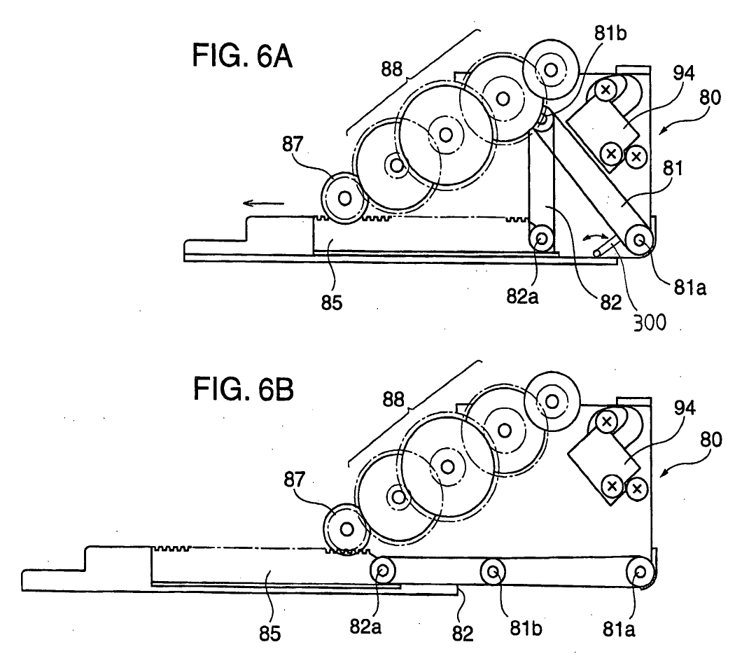

As shown in FIGS. 5A and 6A, the coupling member 82 extends along the bill stacked direction with the shield plate 81 closed. By the pair of rack members 85 being driven to slide (driven to be pulled) from the state as shown in FIGS. 5A and 6A to the state as shown in FIGS. 5B and 6B, the coupling member 82 comes into between the stored stacked bills and a wall of the frame, and when the rack members 85 are further driven to slide, is rotated to the almost the same plane with the rack members 85 as shown in FIGS. 5B and 6B. Then, with the operation of the coupling members 82, the shield plate 81 is rotated to fall down toward the inside of the apparatus about the one end portion 81a as a center and come into contact with the frame wall, and finally opens the ejection path of the bills to enable the bills to be removed.

In addition, as shown in FIGS. 2 and 6(6A, 6B), the above-mentioned rack members 85 are engaged in gear trains 88 with the same structure installed at opposite sides of the frame via pinions 87, 87. Then, each of the gear trains 88 is coupled to a rotary driving shaft 89 rotary-driven by a shutter motor 90 disposed at one side of the frame. In other words, when a motor gear 90G of the shutter motor 90 is coupled to a gear 89G fixed to the rotary driving shaft 89, the rotary driving shaft 89 is rotary-driven, and the pair of rack members 85 are synchronously slide-driven (pull-driven) via the gear trains 88 and pinions 87 disposed at opposite ends of the shaft 89. As a result, the shield plate 81 is driven to open and close as shown in FIGS. 5 and 6.

Then, after the shield plate 81 falls down and is opened as described above, a pushing mechanism (pushing device, pushing means) 100 engages in the bills stored and stacked on the mount plate 10b of the bill storage portion 10, and the stacked bills are forcefully pushed to the opened shield plate 81 side.

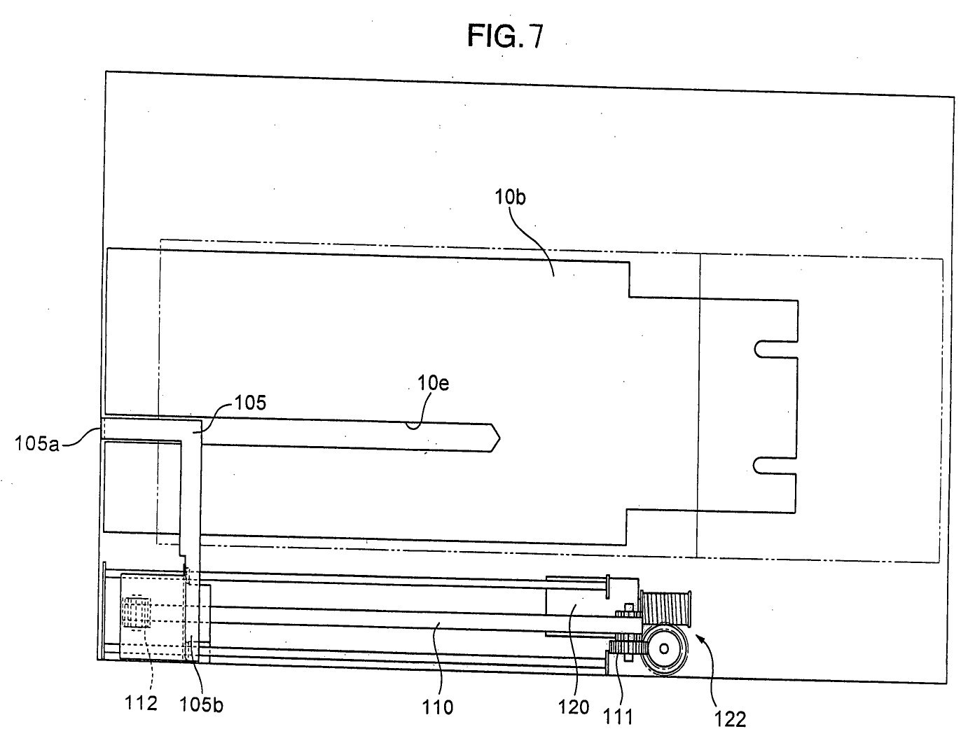

Such a pushing mechanism can be configured as shown in FIGS. 2, 7 and 8(8A, 8B), for example. In other words, a long groove 10e extending along the longitudinal direction of the bill is formed in the mount plate 10b of the bill storage portion 10, and a pushing arm 105 movable along the long groove is disposed. On the one end side of the pushing arm 105 is formed a contact piece 105a that is bent along the stacked direction of bills and that comes into contact with end edges of the stacked bills, and on the other end side is formed a holding portion 105b that holds a driving belt 110 stretched and provided in the frame of the apparatus body to enable rotary driving.

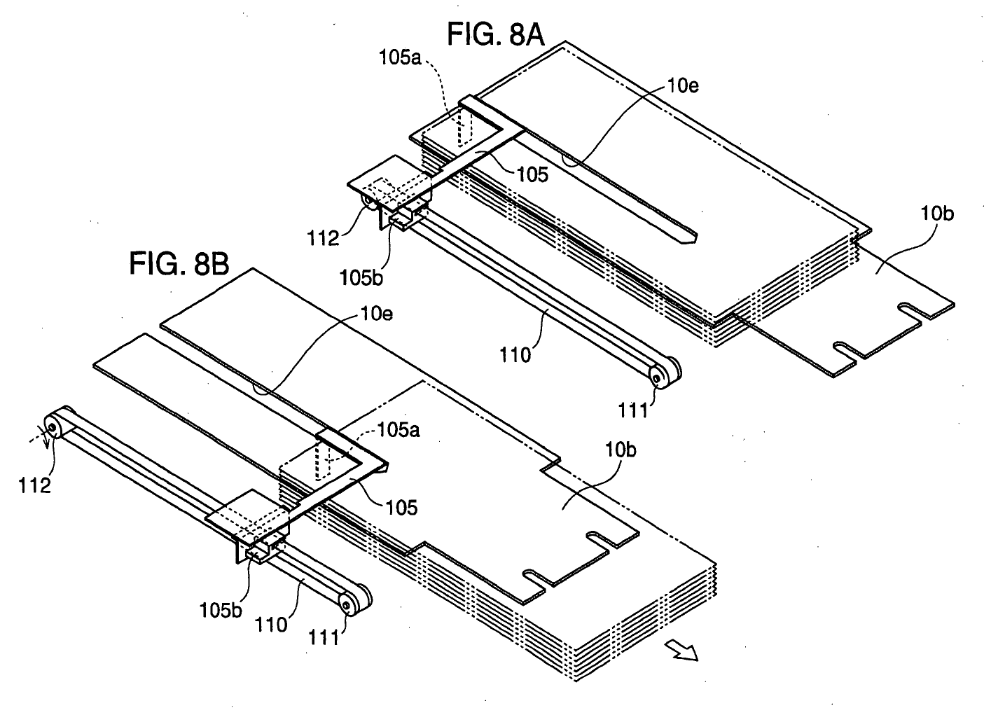

The driving belt 110 are stretched over tension rollers 111, 112 at opposite end portions, and by rotary-driving one of the tension rollers, 111, via a pushing motor 120 provided in the frame of the apparatus body and a gear train 122 coupled to the driving shaft of the motor 120, the pushing arm 105 can be driven in the bill ejection direction. By thus driving the pushing arm 105 to slide, as shown in FIGS. 8A and 8B, the bills stored and stacked on the mount plate 10b are driven to slide without change, and can be ejected via the-opened shield plate 81.

As a result, the shutter mechanism 80 is opened by driving the shutter motor 90, while the pushing motor 120 is driven in synchronization therewith, and the stored stacked bills B can be removed while keeping their state as shown in FIG. 9.

In addition, the shutter mechanism 80 can be provided with a lock mechanism (lock device, lock means) that locks the shield plate 81. For example, the lock mechanism can be configured by providing the frame of the apparatus body with a lock member 300 (see FIGS. 6A and 6B) to come into contact with the shield plate 81 to prevent the plate from falling down, and driving the lock member 300 to be contact state/non-contact state by driving means, for example, a solenoid 94 (see FIG. 6), held in the frame. In this case, the lock member 300 in the lock mechanism can be driving-controlled by control means as described below.

FIG. 10 is a block diagram illustrating an example of a configuration of the control means for controlling the operation of the above-mentioned bill handling device 1.

The control means is comprised of a control circuit board 150 that controls the operation of each of above-mentioned actuators and that is provided with a CPU 130 having the function of controlling the operation of various driving apparatuses such as the feeding motor 20, separation motor 42, pushing motor 120, shutter motor 90 and the like, ROM 131 that stores operation programs of the various driving apparatuses, detection data on the authorized bills and the like, and control RAM 132.

The CPU 130 is connected via an I/O port 135 to a feeding motor driving circuit 140, separation motor driving circuit 141, pushing motor driving circuit 142, and shutter motor driving circuit 143 to drive the various driving apparatuses, and the operation of each of the driving apparatuses is controlled by a control signal from the CPU 130 according to an operation program. Further, to the CPU 130 are input via the I/O port 135 a detection signal from the bill insertion sensor 30, a detection signal from the bill identifying sensor 31, and a detection signal from the bill detecting sensor 125. Based on the detection signals, the feeding motor 20 is controlled to be driven in forward/reverse rotation via the feeding motor driving circuit 140, and the separation motor 42 is controlled to be rotary-driven via the separation motor driving circuit 141. Further, when the existence of a bill is not detected due to the detection signal from the bill detecting sensor 125, the shield plate 81 is locked by the solenoid 94.

The CPU 130 is further connected to a control circuit 200 that is disposed in the game machine body not shown and that executes the game processing, and transmits game value information corresponding to the amount of an inserted bill to the game machine side.

Moreover, to the CPU 130 is input a release signal to release the lock state (drive the solenoid 94) in the lock mechanism. For example, signal transmitting means 300 for transmitting the release signal is connected to a control circuit board 150 via a communication network 400, and can be configured as a part of the function of a management server that manages bank facilities, and it is thus possible to collectively drive and release shutters of bill handling devices in the bank facilities at the work time for collection, for example.

The operation of the bill handling device 1 with the above-mentioned structure will be described below with reference to FIGS. 1 to 4 and FIG. 11. In addition, FIGS. 11A to 11F are schematic views successively illustrating the operation of the bill feeding mechanism 7, guide means 35 and separation mechanism 50 when a bill B is inserted.

First, when the bill B is inserted into the bill insertion slot 3 while letting the bill B stand vertically as shown in FIG. 1, the bill insertion sensor 30 detects the insertion. When the bill insertion sensor 30 detects the insertion of the bill, the feeding motor 20 is driven in forward rotation, and the first feeding mechanism 15 and second feeding mechanism 25 of the bill feeding mechanism 7 are driven to rotate in the direction of the arrow in FIG. 11A. The bill B inserted through the bill insertion slot 3 is whereby introduced to the inside.

At this point, the guide plates 39a, 39b of the guide means 35 are positioned in respective initial positions (only the guide plate 39b is shown in each figure of FIGS. 11A to 11F.) Herein, the initial position is a position such that the front end portion 39e of the arch-shaped guide plate 39b faces toward the bill insertion slot side to enable the front end of the fed bill B to be guided to the clearance between the guide plate 39b and the outer circumference surface of the roller 38c, as shown in FIG. 4A. Further, in the initial position, the guide bar 40 opens the clearance between the guide plates 39a,39b and the outer circumference surfaces of the rollers 38a and 38c, while closing the clearance between the feeding belts 25a, 25b and rollers 38a, 38c, and is ready to enable the front end of the bill to be curved and guided to the peripheries of the rollers 38a, 38c smoothly.

Further, in the initial position, as shown in FIG. 4B, when bills are stacked and stored in the bill storage portion 10, the outer circumference surfaces of the arch-shaped guide plates 39a and 39b are in contact with the end surface of the bill positioned on the bill feeding mechanism 7 side, and thus separate between the stored stacked bills and a newly fed bill. Furtermore, the switching valves 52 are in the positions as shown in FIG. 11A, and when bills are stacked and stored in the bill storage portion 10, in contact with the end surface of the bill (being separated from an inserted bill).

When the bill B is fed inside, the bill identifying sensor 31 detects the bill in a fed state, and the above-mentioned control means judges the validity of the bill. In this case, the bill identifying sensor 31 detects the entire longitudinal direction of the fed bill B (see FIG. 11B). In addition, when the bill B is fed, the switching valves 52 are rotated anticlockwise in FIGS. 11A to 11F against the applied force (urging force) due to the feeding force of the bill.

When the rear end of the bill B is passed by the bill identifying sensor 31 and the sensor has detected the entire longitudinal direction of the bill, the front end of the bill B is guided and curved by the arch-shaped guide plates 39a, 39b of the guide means 35. At this point, the rear end of the bill B is in the position where the rear end has not passed by the switching valves 52 (FIG. 11C).

Then, when the control means does not judge the inserted bill B as being valid, the feeding motor 20 is driven in reverse rotation. By the reverse rotation, the bill B in the state as shown in FIG. 11C undergoes the sending-back action, and is ejected from the bill insertion slot 3. Further, when the bill B is judged as being valid, the feeding motor 20 is driven to rotate until the rear end of the bill B has passed by the switching valves 52 (see FIG. 11D). The switching valves 52 are whereby returned to the initial position of FIG. 11A due to the applied force.

The feeding motor 20 is driven in forward rotation until the rear end of the bill B has passed by the switching valves 52, and then, driven in reverse rotation (switch-back control) to switch the bill back by a predetermined distance. At this point, the rear end portion of the bill B undergoes separation by the switching valves 52, is not fed again to the first feeding mechanism 15 side, and prevented from interfering with a subsequently inserted bill. Further, the front end portion of the bill B is located in the guide introduction portion of the arch-shaped guide plates 39a, 39b, and thus positioned in a state prior to the curved guiding (FIG. 11E). In addition, the switch back control indicates that when the bill is judged to be valid by the bill identifying sensor 31, after the rear end of the bill passes by the switching valves 52 and the front end of the bill is guided and curved by the guide plates 39a, 39b, the driving of the feeding motor 20 is controlled to feed (return) the bill toward the bill insertion slot side by a predetermined distance.

Then, in this state, the separation motor 42 is rotary-driven, and rotates the guide plates 39a, 39b into a 360-degree roll anticlockwise. By this rotation, the front end portion of the bill B is raised on the guide plates 39a, 39b (see FIG. 11F), and when finally plates 39a, 39b being returned to the initial position of FIG. 11A, is kept contact with the mount plate 10b by the outer circumference surfaces of the guide plates 39a, 39b as shown in FIG. 4B. In other words, the switch-backed bill is carried in the direction perpendicular to the bill insertion direction toward the bill storage portion 10 by the rotary-driven guide plates 39a, 39b, while being pressed against the mount plate 10b. Further, a next inserted bill is separated not to interfere with the stacked bills by the guide plates 39a, 39b that are returned to the initial position, and the feeding path is maintained at the open state.

Then, when bills are inserted successively from the bill insertion slot 3, the above-mentioned operation is repeated, and finally, as shown in FIG. 5A, a large number of bills are stacked and stored on the mount plate 10b. In this state, the stored stacked bills are pressed in front end portions against the mount plate 10b side by the guide plates 39a, 39b, while being pressed in rear end portions against the mount plate 10b side by the switching valves 52 (separation is achieved between the stacked bills and a newly inserted bill by the guide plates 39 and switching valves 52).

According to the bill handling device 1 of this embodiment, a bill inserted into the bill insertion slot 3 is fed by the bill feeding mechanism 7 without change, and judged on its validity by the bill identifying sensor 31 during the feeding. Then., when the bill identifying sensor 31 is judging the validity of the bill, the guide means 35 guides the front end of the fed bill to curve. Therefore, even when the bill is detected in the entire region in the longitudinal direction, it is possible to set the length of the feeding path in the longitudinal direction of the bill to be shorter, and it is whereby possible to reduce the depth of the bill handling device 1 as much as possible while enhancing the accuracy in identification of a bill.

Further, the bill judged as being valid is switch-backed to the bill insertion slot 3 side by a predetermined distance, and in this position, the separation mechanism 50 carries the bill toward the bill storage portion 10 disposed in parallel with the bill feeding mechanism 7. In other words, the bill storage portion 10 has the structure to stack and store carried bills in the direction perpendicular to the bill insertion direction, and therefore, is capable of storing bills efficiently in the space limited in the width direction. Then, the separation mechanism 50 opens the feeding path so that a bill subsequently inserted by the bill feeding mechanism 7 does not interfere and the like, and thus, it is possible to feed bills in a stable state without causing the jam and/or clogging between the bill to be stored and stacked and an inserted bill.

Furthermore, in the above-mentioned embodiment, since the arch-shaped guide plates 39a, 39b constituting part of the guide means 35 have both the function of carrying the bill toward the bill storage portion 10 and the separation function of making a separation between the bill to be stored and stacked and an inserted bill, the entire construction can be simplified. The arch-shaped guide plates 39a, 39b further have the function of pressing the bills against the mount plate 10b, and the need is whereby eliminated of separately disposing a member such as a pressing plate.

Then, the bills stored and stacked in the bill storage portion 10 are ejected while keeping their stored stacked state as shown in FIGS. 8 and 9 by the pushing mechanism 100, in a state where the lock mechanism is released, the shutter mechanism is driven and the shield plate 81 is opened. By thus providing the pushing mechanism 100 engaging in the mount plate 10b, the bills stored (on the mount plate) in the bill storage portion 10 can be pushed out and removed with ease without change, and the effort is reduced such that a cassette (safety box) storing bills is removed from the inside, and the bills are removed from the cassette as in the conventional bill handling device. Further, due to the above-mentioned structure, the need is eliminated of installing a cassette or the like inside the apparatus, and it is possible to simplify the structure inside the apparatus and make the entire apparatus compact.

Further, according to the above-mentioned shutter mechanism 80, the operation of opening/closing the shield plate 81 is performed by pulling the coupling member 82 disposed inside the apparatus. Since the shield plate 81 is thus opened and closed only by pulling the coupling member 82, by making the pulling direction the same as the bill feeding direction, the space inside the apparatus can be used efficiently, while it is possible to utilize the space more effectively by pulling the coupling member 82 to under the stored stacked bills as shown in FIG. 5.

Then, at the work time of collecting the bills, when the bill detecting sensor 125 detects that no bill exists on the mount plate 10b (when the collecting operation is finished), the processing is executed that is inverse to the above-mentioned processing procedures after a lapse of predetermined time. In other words, the pushing motor 120 is driven in reverse rotation, the pushing arm 105 is returned to the initial position, the shutter motor 90 is then driven in reverse rotation to turn the shield plate 81 to the closed state, the solenoid 94 is subsequently driven to return the lock member to the initial position, and the lock mechanism is activated.

The lock mechanism is thus activated automatically when detecting that any bills are not present on the mount plate 10b. Therefore, the operator is only required to perform the bill collecting operation without needing to perform other operations, and is capable of performing the bill collecting operation with high efficiency. Further, according to such a constitution, omission (human error) of lock of the shield plate 81 is reliably prevented in the bill collecting operation, and security is whereby enhanced. In addition, the above-mentioned control means may be configured not to release the lock mechanism when a bill is not present on the mount plate 10b in receiving a signal to release the lock mechanism. In other words, in a state where a bill is not present, the lock mechanism remains maintained without driving the pushing arm 105, and it is whereby possible to reliably prevent the lock from being omitted and the like.

In addition, the release of the lock mechanism may be performed by a dedicated portable terminal that the operator possesses. For example, each bill handling device may be provided with an infrared receiving portion 500 (see FIGS. 1 and 10), and release the lock mechanism when receiving a predetermined lock release signal from the portable terminal via the infrared receiving portion. In other words, according to such a constitution, it is possible to release the lock mechanism to perform the collecting operation individually on a large number of bill handling devices. Alternately, such a release operation may be performed collectively by the portable terminal via a management server. In other words, lock mechanisms may be released collectively for the entire bank or for each line of the bank by the operation of the portable terminal.

According to the above-mentioned constitution, at the ordinary time (a bill can be inserted), the shield plate shields the ejection region, and when bills are removed, the shield plate is driven to open the ejection region. In other words, since such a construction is provided that the region into which a bill is inserted and the region from which bills are ejected are divided and that the ejection region is opened by the shield plate when necessary, the bill insertion portion and bill ejection portion can be constructed as a single handling opening. Further, when bills are removed, bills that are stacked and stored in the bill storage portion are ejected from the ejection region in their state without change (while keeping their stacked state).

According to the bill handling device configured as described above, it is possible to perform the bill collecting operation efficiently.

While the embodiment of the present invention is described in the foregoing, as well as the above-mentioned embodiment, the invention is capable of being carried into practice in following constitution, for example.

The present invention requires the constitution to curve and guide a front end of a bill in feeding the bill of which the validity is being identified, while switching back the bill judged as being valid by a predetermined distance, and then, enable the bill to be carried toward the bill storage portion, and it is possible to modify as appropriate the structure of the separation mechanism and a scheme of separating the bill to be stored and stacked. Further, with respect to the guide means for curving and guiding the bill, and the separation mechanism for carrying the bill toward the bill storage portion and making a separation between the bill to be stored and stacked and the fed bill, as well as the structures having different functions as in the above-mentioned embodiment, such structures may be configured so that each independent function is exhibited. Further, it is possible to modify as appropriate the bill feeding mechanism that feeds a bill, the structures of driving sources for driving the bill feeding mechanism and the like, the structure of the power conveying mechanism and the like. Furthermore, it is possible to modify as appropriate the shutter mechanism 80, the structure of the pushing mechanism 100, and the operation method.

The bill handling device of the present invention is capable of being installed in various apparatuses that handle bills, for example, outside apparatuses such as various vending machines, as well as being installed between various game machines.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A bill handling device comprising:
a casing having a bill handling opening enabling a bill to be inserted therein;
a bill feeding device-for feeding the bill-inserted from the bill handling opening along the insertion direction, and for feeding the bill in an insertion state back to the-bill handling opening;
a bill identifying sensor that identifies the validity of the bill inserted into the bill handling opening;
a guide device for curving and guiding a front end of the bill in a fed state when the bill is in the fed state along the insertion direction and the bill identifying sensor is detecting the validity of the bill;
a bill storage portion that is provided in parallel with the bill feeding device and that stacks and stores the bill in the direction perpendicular to the bill insertion direction;
a control device for controlling switch back of the bill feeding device so as to feed the bill to the bill handling opening side by a predetermined distance when the inserted bill is valid; and
a separation device that stacks and stores the switch backed bill in the bill storage portion, while making a separation between the bill and a subsequently inserted bill.

2. The bill handling device according to claim 1, wherein the guide device has an arch-shaped guide plate that curves and guides the bill, and the separation by the separation device is made by the guide plate.

3. The bill handling device according to claim 2, wherein the guide plate carries the bill toward the bill storage portion.

4. The bill handling device according to claim 2, wherein the bill storage portion has a mount plate that stores stacked bills, and the guide plate pushes the bill against the mount plate.

5. The bill handling device according to claim 1, wherein the bill handling opening is divided into an insertion region enabling a single bill to be passed through and an ejection region enabling stored stacked bills to be collectively ejected while keeping their stacked state, and the ejection region is shielded by an openable/closable shield plate when a bill is inserted.

6. The bill handling device according to claim 5, wherein the shield plate is coupled to a rotatable coupling member, falls down by pulling the coupling member in the bill insertion direction, and whereby releases the ejection region.

7. The bill handling device according to claim 5, further comprising:
a bill detecting sensor that detects that a bill is stored in the bill storage portion; and
a lock device that locks the shield plate,
wherein the control device locks the shield plate to block opening of the ejection region by the lock device when the bill detecting sensor does not detect the existence of a bill.

8. The bill handling device according to claim 1, wherein the bill storage portion has a mount plate that stores stacked bills, further comprising a pushing device which comes into contact with the stacked bills stored on the mount plate to enable the bills to be carried to the bill handling opening side.

9. The bill handling device according to claim 5, wherein the bill storage portion has a mount plate that stores stacked bills, further comprising a pushing device which comes into contact with the stacked bills stored on the mount plate to enable the bills to be carried to the bill handling opening side.

10. The bill handling device according to claim 9, wherein the pushing device is driven synchronously with the opening operation of the shield plate.

11. The bill handling device according to claim 9, wherein the guide device has a roller disposed between the guide plate and the bill feeding device, and has a guide bar preventing the bill from coming into between the bill feeding device and the roller, while guiding the bill toward the guide plate.

12. The bill handling device according to claim 11, wherein the guide bar is integrally formed with the guide plate.

13. The bill handling device according to claim 11, wherein the separation device has switching valve disposed between the bill feeding device and the bill storage portion, and the switching valve cooperates with the guide plate for the separation, by switching between a position where the switch backed bill is stacked and stored in the bill storage portion and a position for enabling the insertion of a subsequently inserted bill.

14. A bill handling device comprising:
a casing having a bill handling opening enabling a bill to be inserted therein;
bill feeding means for feeding the bill inserted from the bill handling opening along the insertion direction, and for feeding the bill in an insertion state back to the bill handling opening;
bill identifying means for identifying the validity of the bill inserted into the bill handling opening;
guide means for curving and guiding a front end of the bill in a fed state when the bill is in the fed state along the insertion direction and the bill identifying means is detecting the validity of the bill;
bill storage means provided in parallel with the bill feeding means, for stacking and storing the bill in the direction perpendicular to the bill insertion direction;
control means for controlling switch back of the bill feeding means so as to feed the bill to the bill handling opening side by a predetermined distance when the inserted bill is valid; and
separation means for stacking and storing the switch backed bill in the bill storage portion, while making a separation between the bill and a subsequently inserted bill.

15. The bill handling device according to claim 14, wherein the guide means functions as the separation means.

16. The bill handling device according to claim 14, wherein the guide means carries the bill toward the bill storage means.

17. The bill handling device according to claim 14, wherein the guide means pushes the bill against the bill storage means.

18. The bill handling device according to claim 14, wherein the bill handling opening is divided into an insertion region enabling a single bill to be passed through and an ejection region enabling stored stacked bills to be collectively ejected while keeping their stacked state, and the ejection region is shielded by an openable/closable shield plate when a bill is inserted.

19. The bill handling device according to claim 18, further comprising:
bill detecting means for detecting that a bill is stored in the bill storage means; and
lock means for locking the shield plate,
wherein the control means locks the shield plate to block opening of the ejection region by the lock means when the bill detecting means does not detect the existence of a bill.

20. The bill handling device according to claim 14, further comprising pushing means for coming into contact with the stacked bills stored on the bill storage means to enable the bills to be carried to the bill handling opening side.
